(19) United States
(12) Patent Application Publication
(10) Pub. No.: US 2008/0320167 A1
(43) Pub. Date: Dec. 25, 2008

(54) Method and a Device for Recomposing an Url

(75) Inventor: Francois-Luc Collignon, Wiltz (LU)

Correspondence Address: SUGHRUE MION, PLLC, 2100 PENNSYLVANIA AVENUE, N.W., SUITE 800, WASHINGTON, DC, 20037, US

(73) Assignee: DNS Holding SA, Wiltz (LU)

(21) Appl. No.: 11/815,810

(22) PCT Filed: Feb. 9, 2006
(86) PCT No.: PCT/EP06/01157

§ 371 Date: Apr. 4, 2008

Related U.S. Application Data
(60) Provisional application No. 60/650,983, filed on Feb. 9, 2005.

(51) Int. Cl. G06F 15/173

(52) U.S. Cl. 709/245

(57) ABSTRACT

A method and a device for recomposing an URL having caused the generation of an error message. Said URL being scanned in order to detect among its characters a presence of one or more characters belonging to a list of predetermined characters. A substitution by an assigned substitute character being applied if said scanning issued in a matching with a character of said list. If no matching occurred the domain name and the TLD are compared with a further domain name or URL belonging to a dictionary. If a matching with the dictionary occurred, a substitution with the domain name or URL of the dictionary is carried out. If no match occurred, a spelling correction algorithm is applied. If the spelling corrections still did not result in a corrected URL, the latter is segmentwise divided and recomposed.

The present invention relates to A method for recomposing an URL, said method comprises:
monitoring a generation of an error message generated by a user's computer upon receipt of an URL composed of characters, forming at least a domain name and a TLD and supplied by said user, said error message comprising a data field identifying said error and being generated consequently to said URL not matching with a recognisable Internet Protocol address;
retrieving, upon generation of said error message, said URL having caused said generation of said error message and re-routing said retrieved URL towards an URL recomposing station.

Such a method is known and used in order to help a user who, for example typed an URL with a domain name that is no longer used. The outdated domain name is recognised and substituted by the actual one. Also search engines like Google are provided for detecting an erroneous URL and for proposing an alternative to the user.

A drawback of the known methods is that they are insufficiently performant and are generally only able to correct a spelling error in a single character of the URL. Therefore most of the time that a user types an incorrect URL or selects a hyperlink, which is incorrect, he does not get access to the requested site and simply gets an error message indicating that the requested URL is either unknown or could not be found. Such kind of messages mostly upset the user, who can not get access to the information he wants.

The object of the present invention is to offer the user, in particular the internante a more performant tool for recomposing an URL and thus to offer him a better chance to access the desired Internet site when he used an erroneous URL.

For this purpose, the method according to the present invention is characterised in that said method further comprises:
scanning within said recomposing station said retrieved URL in order to detect among its characters a presence of one or more characters belonging to a list of predetermined characters, said list further comprising for each of said predetermined characters a substitute character, and wherein upon detection of such a predetermined character the latter is substituted by its assigned substitute character in order to form a substitute URL from said retrieved URL;
separating within said substitute URL said domain name and said TLD;
comparing said domain name with a further domain name belonging to a dictionary of domain names and, upon matching of said domain name with said further domain name, recomposing said substitute URL by substituting said domain name by said further domain name in order to recompose said URL;
if no recomposed URL resulted from the previous step, comparing said TLD with a further TLD belonging to a dictionary of TLD's and, upon matching of said TLD with said further TLD, recomposing said substitute URL by substituting said TLD by said further TLD in order to recompose said URL;
if no recomposed URL resulted from the previous step, applying a spelling correction algorithm on said domain name and if said application thereof results in a modified domain name, substituting said domain name by said modified domain name in order to recompose said URL;
if no recomposed URL resulted from the previous step, dividing said domain name into segments and for each segment verifying if said segment is linguistically acceptable, if said segment is not linguistically acceptable, substituting said segment by a linguistically acceptable segment having a number of characters in common with said segment, recomposing said URL by using said substituted segments;
presenting said recomposed URL to said user.

By substituting an apparent wrong character by a substitute character, the correct URL could be formed, thus immediately routing the user to the correct site or at least proposing the internante an appropriate URL. As usually the same typing errors are made such as for example the typing of a “z” or “e” instead of an “a”, it is possible to build up a dictionary where such errors are considered. The use of such a dictionary then helps to easily and rapidly find the correct URL. If the correct URL could not be found in the dictionary, a spelling correction algorithm is applied on the domain name. As errors in URL's are often due to spelling errors, the use of a spelling correction algorithm could further help to obtain the correct URL and thus to find the requested URL. If the spelling correction algorithm does not provide a solution, then the domain name is split into segments and the segments are processed separately in order to recompose the domain name. The method according to the invention thus offer a succession of steps for recomposing an URL, that caused an invalid request. By making several correction attempts, such a proposed by the present method, the probability that the desired Internet site will be accessed is substantially increased.

A first preferred embodiment of a method according to the present invention is characterised in that said list of predetermined characters comprises a sub-list formed by characters expressing a coupling or a splitting property, each of said characters of said sub-list having as substitute character a spacing character in order to form a fragmented domain name. Characters, having a coupling or splitting property provide a reliable manner to subdivide the domain name into segments and thus to analyse segmentwise the different segments composing the domain name.

A second preferred embodiment of a method according to the present invention is characterised in that after separation from the URL, said TLD is scanned in order to detect an unrelated character, and wherein upon detection of said unrelated character the latter is removed. Since the number of characters forming a TLD is rather limited, a scanning of the TLD, in order to detect unrelated characters, is easily and quickly to realise and enables thus to correct the TLD and address the requested site if the error was present in the TLD.

A third preferred embodiment of a method according to the present invention is characterised in that said subdividing of said domain name into segments is based on segments having a predetermined number of characters, each segment being scanned in order to detect common characters between the one of the segment and a comparable word in said dictionary, each time that a common character is detected a score being attributed, and wherein a correspondence rate being determined among the segments based on said score, said comparable word having obtained the highest score being selected as substitute. By setting an upper limit to the number of characters in a segment, it becomes easier to subdivide into segments. Moreover, the allocation of a score when a common character is detected, renders the selection of a substitute more easy.

Preferably a lower threshold is defined for said score, wherein, if none of the scores reached said threshold, no substitute is proposed. By setting a lower threshold, the method becomes more efficient as substitutes, which have a small probability to be successful, are no longer considered.

Preferably upon retrieving said URL a time data indicating an actual time is also retrieved and annexed to said URL. The actual time can under certain circumstances be of help to find the right URL.

The invention also relates to a device for carrying out the method.

The invention will now be described in more details with reference to the annexed figures illustrating a preferred embodiment of a method and a device according to the present invention. In the drawings:

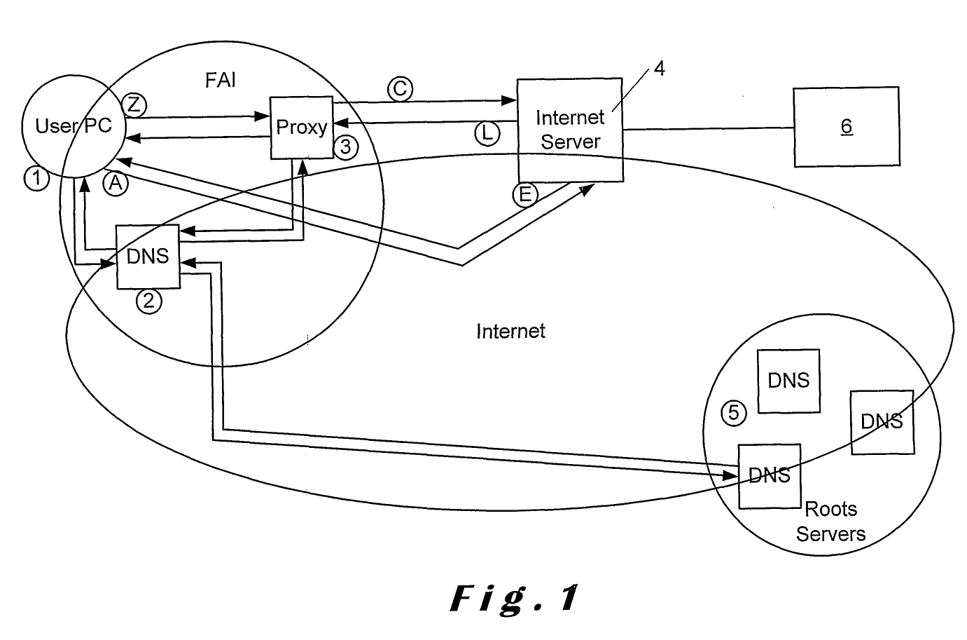

FIG. 1 illustrates schematically an Internet access;

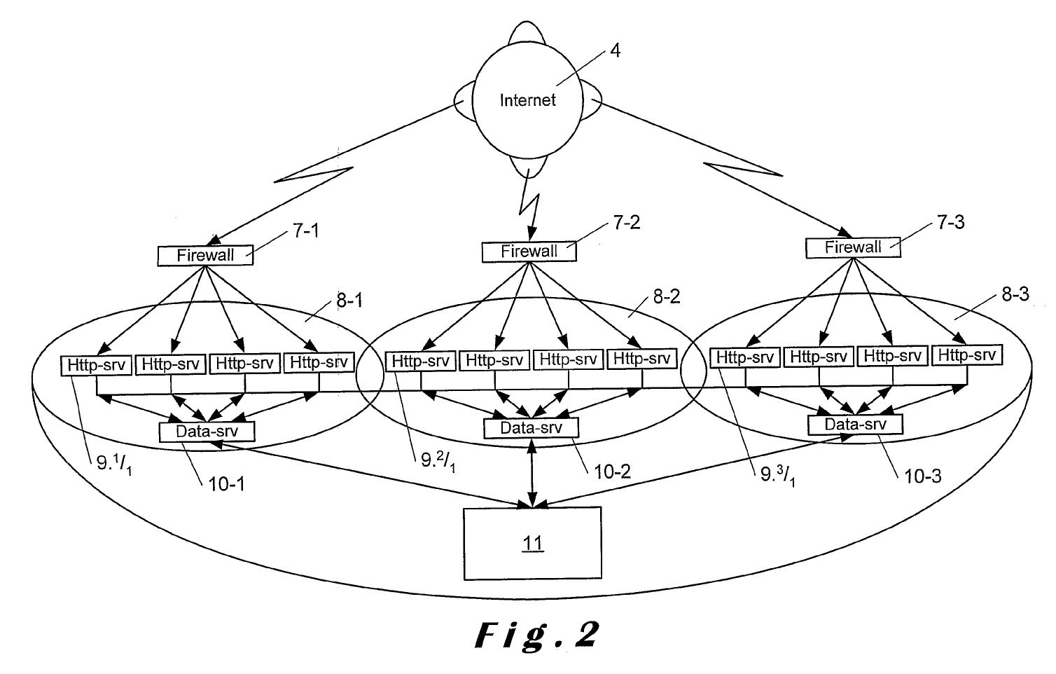

FIG. 2 illustrates the architecture of a device for implementing the method according to the present invention; and

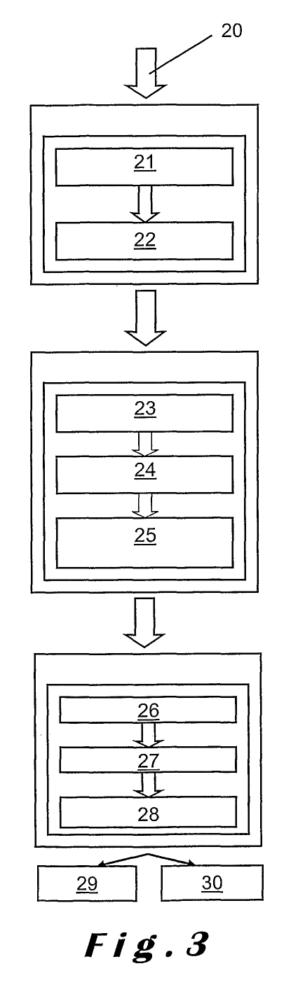

FIG. 3 shows the different steps for processing an URL.

In the drawings a same reference sign has been allocated to a same or analogous element.

FIG. 1 illustrates schematically the paths followed upon requesting an Internet site. A user, also called an internante, has a computer 1, generally a PC (Personal Computer), provided with the necessary software in order to enable an Internet access. The computer 1 is connected, for example via a telephone line, to a DNS (Domain Name Server) 2. The lafter is equipped to transform an URL into an IP (Internet Protocol) address. Each URL is formed by at least three parts:
1. TLD (Top Level Domain) being the domain name with the highest hierarchy level and which is generally at the end of the URL. Known TLD's are for example “com”, “org”, “mil”, “gov”, “eu” and country codes like “be”, “de”, “lu”, etc. . . . .
2. The domain name, indicating the name allocated to a particular instance, firm or in general the name of the site. An example of the domain name is “epo” belonging to the European Patent Office's Internet address (ww.epo.org);
3. The host name, being “www” (World Wide Web) or “http”.

When the user forms an URL, such as for example www.domainname.com, the DNS (2) receives this URL and transforms the word “domainname” into the IP address (for example: 192.xxx.xxx.xxx). For this purpose the DNS could already have the address in his cache memory and then it simply retrieves the IP address from its cache memory. If the IP address is not in the cache memory, then the DNS addresses a root server 5 where the domain name is hosted. The root server will then send the requested IP address to the DNS. Once the IP address is available, the latter is sent over the Internet to a server 4 in order to reach the server having the used IP address and to retrieve at this server the necessary information available on the requested site.

The PC (1) of the user is also in contact with a Proxy (3) which stores a number of IP addresses, generally those most frequently used by the user. Each time when the user forms an URL, be it via a keyboard or via hyperlink, the URL is transmitted to the Proxy 3, which will retrieve the requested data from the addressed server on the Internet. The Proxy will, in order to address the requested site stored in its internal memory, use the IP address. When the requested data is already in its cache memory, because there has been an earlier request, the requested data will be directly retrieved from the cache memory of the Proxy.

It can happen that the user types a wrong URL, for example due to a typing error, or due to a misunderstood information, which will lead to an URL, which can not be recognised by the Proxy or the DNS. It could also be that the user generates a request by using a hyperlink comprising an error. Such errors are for example the use of one or more wrong characters in the domain name i.e. spelling errors, the omission of one or more characters or the presence of too much characters in the URL. In all those cases, the Proxy or DNS is not able to assign the correct IP address as the URL is unrecognisable for the Proxy or the DNS and does not match with a recognisable IP address. An error message indicating that the URL is wrong, will then be generated and supplied if necessary to the user. The error message comprises a data field identifying the error.

The generation of such an error message is the point where the method according to the present invention is triggered. At the level of the DNS 2 or the Proxy 3, monitoring means are installed in order to monitor the generation of such an error message. The detection of the latter will cause the URL having provoked the error message to be retrieved by the monitoring means and rerouted towards an URL recomposing station 6 connected to the Internet.

When the monitoring means have recognised an error message, they will pick up the URL having caused the error message and add an HTML code to the pages using the http protocol. The Proxy or DNS will also when recognising the error in the URL, identify the error type and the erroneous data. The error type and erroneous data information are also preferably supplied to the recomposing station 6.

The monitoring means present at the stage of the DNS will also substitute the NX DOMAIN message indicating a non-existing domain, into the IP address of the recomposing station 6. It could also be envisaged to apply a selection among the error message and to reroute only errors of a predetermined type, such as for example only those related to A type requests i.e. those requests which are linked to acceptable registrations of domain names. In such a manner anti-spam filters will be able to always validate the servers having sent the e-mail by using an inversed domain name. Inversed domain name signifies that the IP address rather than the domain name is used.

Rerouting the URL is controlled by the ACL (Access Control List in/out). One of those ACL's reroutes an IP list or class, whereas another ACL retrieves an IP address or an IP class. While the URL is rerouted, the user also preferably receives a message indicating that the generated URL has been rerouted. Moreover, the monitoring means could also propose to reroute URL's comprising a valid and recognised domain name. For legal reasons, providers must be able to deactivate certain valid domain names proposing illegal subject matter or leading to sites due to a contamination of the PC by a Spyware. Some examples thereof are given below.
a request (a)
   Domain name MX mail exchange request (b)
NS request to server having authority
on the domain (c)

true→IP server

(a)

false→towards recomposing station

true→IP server MX zone

(b)

false→NXDOMAIN

true→IP server NS zone

(c)

false→NXDOMAIN

In order to provide an efficient recomposing station, the latter preferably has an architecture as illustrated in FIG. 2. The recomposing station is connected to the Internet 4 and comprises a number of firewalls 7-1, 7-2, 7-3. The latter filters all the input requests and select only those addressed to the recomposing station. Each firewall serves a grappe 8-1, 8-2, 8-3 comprising a number of http-servers 9.1/1, . . . 9.2/1, . . . 9.3/1. The http servers of a same grappe are connected to a database server 10-1, 10-2, 10-3, which on its turn is connected to a processing server 11. All the grappes 8 served by a same processing server 11, form together a platform. The http servers 9 are provided for detecting and filtering harmful input such as viruses. They also analyse syntax errors and are provided for scanning and analysing the received URL's in order to detect the error and propose a corrected URL. The database servers 10 supply the http-servers with data, preferably by using a cache memory and recuperate transactions in order to supply them to the processing server 11. The function of this processing server is to recuperate information from the database servers 10, analyse them and process them in order to render them useful.

If an error message has been generated, it will be rerouted towards the recomposing station either via the Proxy or via the DNS. The Proxy is provided for rerouting the URL having caused the generation of an error message and to add to this URL some additional data. The DNS directly reroutes the URL to the recomposing station. When an URL is rerouted, the recomposing station will also receive the header data. An example of the data transmitted to the recomposing station is given below.

| GET/HTTP/1.1 | REQUEST |
|---|---|
| Host : www.golog.net | Requested domain name |
| User-Agent : Mozilla/5.0 | Type of Internet navigator |
| (Windows; U; Windows NT 5.1; | |
| en-US; rv : 1.8b5) Gecko/20051006 | |
| Firefox/1.4.1 | |
| Accept: | Type of files accepted by navigator |
| Text/xml, application/xml, | |
| application/xhtml+xml, text/html; | |
| q=0.9,text/plain; q=0.8, image/png, | |
| */*; q=0.5 | |
| Accept-Language : en-us, en; | Default language |
| q=0.5 | |
| Accept-Charset : ISO-8859-1, utf-8; | Default character type |
| q=0.7, * ;q=0.7 | |
| Referer : http/www.golog.net/ | Page of the requested URL |

When a “referer” is present, i.e. when the URL, which provoked the generation of the error message originates from a hyperlink, the domain name present in the “referer” is retrieved and used in combination with the one of the URL. This will enable a comparison between the “referer” and the URL, which comparison will permit some processing as described hereafter. The “referer” indicates the address of the last requested URL and comprises a domain name and the path followed by the URL.

When a rerouting occurs, the day and the actual time at which such rerouting occurs is preferably also transferred to the recomposing station. Moreover, geographic location data is preferably deduced from the URL and transmitted to the recomposing station. This geographic location data is deduced from the geographic connection point of the user and his IP address. The “reverse” IP could also be used in order to recognize the geographic region from which the user issued the URL. The day and actual time and the geographical location data are useful information for correcting the URL.

Data originating from a pre-charging of a web-page could also be sent to the recomposing station. This process enables to add a javascript request to each HTML page loaded by the user. This addition enables to add advertising data when a recomposed URL is presented to the user.

The different steps executed by the recomposing station in order to recompose the URL having caused an error message are illustrated in FIG. 3. When an URL is rerouted (20) a material filtering process (21) is applied on the URL. This material filtering is carried out by using hardware components generally used in a firewall and enabling an analysis of each TCP/IP frame. Such an analysis comprises for example:
a) a package filtering of the IP, which is a verification of the header of the IP address, in order to validate the address sources and destination addresses. This filtering corresponds to access lists positioned on a router
b) a status package filtering, wherein the status of the communication is verified. This includes for example a sequence numbers check and a communication coherence check;
c) an application level filtering, which includes a verification of the coherence and the content of the protocol data.

After having applied a material filtering, a logic filtering (22) is applied by the http server. Such a logic filtering is based on the “rewrite” function of the web-server software. The filtering makes use of a list of expressions which, when recognised, deletes the request. The result of this operation could be the closing of an access route by a reset answer.

After filtering, the URL is split into sections by the http server. If necessary the URL is decoded (23), followed by an elimination (24) of particular characters such a for example à, é, è, ü, which are transformed in a, e, e, u respectively. Thereafter the URL is sectioned (25) at the level belonging to a sub-list and expressing a coupling or a splitting property, such as for example “,”; “.”; “&”; “+”; “+”, . . . . Those characters are substituted by a spacing character in order to form a fragmented domain name. So, for example if the domain name comprises “terra+world” the section operation will result in “terra world”. The fact that the user was typing “+” could be due to a natural language error where instead of “+” it should have been “and”. By sectioning the URL at the level of the character “+”, the relevant words “terra” and “world” can be retrieved for further processing.

The sectioning of the URL also enables to separate those parts of the URL which do not contain domain name data such as http://www. The TLD is also separated in order to analyse it separately. It can thus generally be mentioned that the recomposing station scans the received URL in order to detect among its characters a presence of one or more characters belonging to a list of predetermined characters. As already described, such characters are for example “à, +, ü, . . . ). The list comprises for each character it contains a substitute character. So, for example the substitute character of “ü” is “u”. When the scanning operation results in the detection of such a character contained in the list, this character will be replaced by its substitute in order to form a substitute URL Once the substitute URL has been formed, an attempt could already be made, in order to check if the substitute URL leads to a valid request on the Internet. If this is the case, the substitute URL is proposed to the user and the recomposing is terminated.

After sectioning the URL, the analysis of the URL can start in order to recompose the URL. Three types of analysis will be carried out. First an “SPE” (26) analysis will be carried out. This SPE analysis consists in a comparison of the domain name, or substitute domain name if any with a further domain name belonging to a dictionary of domain names. So, for example if the substitute domain name corresponds with a further domain name, present in the dictionary, a match will occur between the substituted domain name and the further domain name. The URL will then be recomposed by substituting the further domain name by the present one. The URL comprising now the further domain name will be proposed (24) to the user, thereby terminating the recomposing operation.

If the “SPE” analysis of the domain name did not result in a recomposed URL, the TLD will be compared with a further TLD belonging to a dictionary of TLD's. When a match between the actual TLD and a further TLD is obtained, the further TLD will substitute the actual one and the URL will be recomposed by using the further TLD. The recomposed URL will then also be presented to the user and the recomposing process will be terminated. The SPE analysis can be applied on the whole domain name and a fragment thereof, If the SPE analysis on both the domain name and the TLD did not result in a recomposing of the URL, then a further analysis called “SPE-” will be carried out (27), The “SPE-” analysis enables an inversion of the domain name, the addition or deletion of one or more characters. So, for example if the original URL mentioned “ddmain” the “SPE-” analysis is able to modify “ddmain” in “domain”, if this modification is present in the dictionary or results from applying a spelling correction algorithm. Indeed, errors in a domain name often result from spelling errors which are made when typing the URL. The “SPE-” analysis allows to apply a spelling correction algorithm on the domain name. If the application of this spelling correction algorithm results in a modified domain name, the latter will substitute the original domain name thereby creating a recomposed URL.

Several spelling correction algorithms could be used. The algorithm based on a Livenshtein distance is however preferred. Upon implementing this algorithm a Livenshtein distance of maximum 2 is preferred, which means that two characters are corrected. If a further domain name of the dictionary produces a Livenshtein distance smaller than two, the analysis will be stopped and a modified domain name is proposed to the user. The algorithm is applicable both on the complete domain name and on fragments thereof resulting from the fragmentation applied under step 25.

If the “SPE-” analysis didn't have a result, a further analysis called “ALL” will be carried out (28). The “All” analysis is based on searching a domain name, which is “close” to the original one. For the “All” analysis, the domain name or substitute domain name is divided into segments and the analysis is segmentwise carried out. For each segment there will be verified if it is linguistically acceptable. If not, the segment is substituted by a linguistically acceptable one, having a number of characters in common with the original segment.

The original domain name could for example be “muddmain”. The segmentation will then result in “mu” and “ddmain”. “ddmain” is linguistically not acceptable whereas “domain”, which is close, is acceptable. “mu” is probably due to a typing error and could be replaced by “my”. The recomposed domain name will then be “mydomain”. In order to realise such modification, fuzzy logic algorithms are preferably used. The principle of such an algorithm is to decompose the domain name into segments of two to five characters and to compare common characters between the segment and a linguistically comparable one. The common number of characters will lead to a score qualifying the level of correspondence. For each group of common characters, the frequency at which such a group of characters occurs will then be multiplied by the number of characters within the considered group. The thus obtained results for all the groups are added and this end result is divided by 1000 in function of the size of the compared expression. A correspondence rate of 1000 being thus a complete match. So, each time that a common character is detected, a score is allocated. The compared word having thus obtained the highest score will then be selected. A lower threshold for the score will be defined so that if none of the allocated scores reached the threshold, no substitute is proposed.

For example, in a comparison between “nomdedoamine” et nomdedomaine”, groups having 2, 3, 4 and 5 characters in common with both words will be formed i.e. no, nom, nomd, nomde, om, omd, omde, omded etc. . . . . Applying the algorithm will give a score of 840. Finally, if two words reach a same score, the one having most of the characters will be selected.

The results of each recomposing operation will be stored (30) in the database by the recomposing station in order to keep statistics and provide self-learning capacities to the system.

1. A method for recomposing an URL, said method comprises:
monitoring a generation of an error message generated by a user's computer upon receipt of an URL, composed of characters forming at least a domain name and a TLD and supplied by said user, said error message comprising a data field, identifying said error and being generated consequent to said URL not matching with a recognisable Internet Protocol address;
retrieving, upon generation of said error message, said URL having caused said generation of said error message and re-routing said retrieved URL towards an URL recomposing station;
characterised in that said method further comprises
scanning within said recomposing station said retrieved URL in order to detect among its characters a presence of one or more characters belonging to a list of predetermined characters, said list further comprising for each of said predetermined characters a substitute character, and wherein upon detection of such a predetermined character the latter is substituted by its assigned substitute character in order to form a substitute URL from said retrieved URL;
separating within said substitute URL said domain name and said TLD;
comparing said domain name with a further domain name belonging to a dictionary of domain names and, upon matching of said domain name with said further domain name, recomposing said substitute URL by substituting said domain name by said further domain name in order to recompose said URL;
if no recomposed URL results from the previous step, comparing said TLD with a further TLD belonging to a dictionary of TLD's and, upon matching of said TLD with said further TLD, recomposing said substitute URL by substituting said TLD by said further TLD in order to recompose said URL;
if no recomposed URL resulted from the previous step, applying a spelling correction algorithm on said domain name and if said application thereof results in a modified domain name, substituting said domain name by said modified domain name in order to recompose said URL;
if no recomposed URL resulted from the previous step, dividing said domain name into segments and for each segment verifying if said segment is linguistically acceptable, if said segment is not linguistically acceptable, substituting said segment by a linguistically acceptable segment having a number of characters in common with said segment, recomposing said URL by using said substituted segments;
presenting said recomposed URL to said user.

2. A method as claimed in claim 1, characterised in that said list of predetermined characters comprises a sub-list formed by characters expressing a coupling or a splitting property, each of said characters of said sub-list having as substitute character a spacing character in order to form a fragmented domain name.

3. A method as claimed in claim 2, characterised in that said comparing step is carried out on the fragments of said fragmented domain name.

4. A method as claimed in claim 1, characterised in that after separation from the URL, said TLD is scanned in order to detect an unrelated character, and wherein upon detection of said unrelated character the latter is removed.

5. A method as claimed in claim 1, characterised in that said spelling algorithm is formed by a Livenshtein algorithm with a distance of two.

6. A method as claimed in claim 1, characterised in that said dividing of said domain name into segments is based on segments having a predetermined number of characters, each segment being scanned in order to detect common characters between the one of the segment and a comparable word in said dictionary, each time that a common character is detected a score being attributed, and wherein a correspondence rate being determined among the segments based on said score, said comparable word having gained a highest score being selected as substitute.

7. A method as claimed in claim 6, characterised in that a lower threshold being defined for said score, and wherein if none of the scores reached said threshold, no substitute is proposed.

8. A method as claimed in claim 1, characterised in that upon retrieving said URL a time data indicating an actual time is also retrieved and annexed to said URL.

9. A method as claimed in claim 1, characterised in that upon retrieving said URL a geographic localisation data is deduced from said URL and annexed to said URL.

10. A device for recomposing an URL, said device comprising:
monitoring means provided for monitoring a generation of an error message generated by a user's computer upon receipt of an URL composed of characters forming at least a domain name and a TLD and supplied by said user, said error message comprising a data field identifying said error and being generated consequent to said URL not matching with a recognisable Internet Protocol address;
retrieving means provided for retrieving, upon generation of said error message, said URL having caused said generation of said error message and re-routing said retrieved URL towards an URL recomposing station;
characterised in that said recomposing station comprises:
scanning means provided for scanning said retrieved URL in order to detect among its characters a presence of one or more characters belonging to a list of predetermined characters, said list further comprising for each of said predetermined characters a substitute character;
substitution means provided for, upon detection of such a predetermined character substituting the latter by its assigned substitute character in order to form a substitute URL from said retrieved URL separating within said substitute URL said domain name and said TLD;
comparing means provided for comparing said domain name with a further domain name belonging to a dictionary of domain names and, upon matching of said domain name with said further domain name, supplying said further domain name to said scanning means, which are further provided for recomposing said substitute URL by substituting said domain name by said further domain name in order to recompose said URL, said comparing means being further provided, if no recomposed URL resulted from the previous step, for comparing said TLD with a further TLD belonging to a dictionary of TLD's and, upon matching of said TLD with said further TLD, supplying said further TLD to said scanning means, which are further provided recomposing said substitute URL by substituting said TLD by said further TLD in order to recompose said URL,
spelling correction means provided for applying a spelling correction algorithm on said domain name, if no recomposed URL was generated by the substitution means, said spelling correction means being further provided, if said spelling correction results in a modified domain name, for substituting said domain name by said modified domain name in order to recompose said URL;
separating means provided for, if no recomposed URL resulted from the spelling correction means, separating said domain name into segments and for each segment verifying if said segment is linguistically acceptable, and for, if said segment is not linguistically acceptable, substituting said segment by a linguistically acceptable segment having a number of characters in common with said segment, recomposing said URL by using said substituted segments.
